(19) United States
(12) Patent Application Publication
(10) Pub. No.: US 2013/0065076 A1
(43) Pub. Date: Mar. 14, 2013

(54) NICKEL OXIDE MITIGATION LAYER FOR VANADIUM ON THERMAL BARRIER COATINGS

(71) Applicant: Richard Todd Everhart, Simpsonville, SC (US)

(72) Inventor: Richard Todd Everhart, Simpsonville, SC (US)

(21) Appl. No.: 13/229,961

(22) Filed: Sep. 12, 2011

(51) Int. Cl. B32B 15/00; B05D 3/02; B05D 3/04

(52) U.S. Cl. 428/632; 427/343; 427/8

(57) ABSTRACT

A method for applying a protective coating to gas turbine engine components using a saturated solution of nickel acetate tetrahydrate, applying a uniform thickness of the coating onto the thermal barrier coating of selected components, and heat treating the coated component in air at a temperature sufficient to form a protective layer of NiO. The saturated NiO solution has sufficient solubility to penetrate into the microscopic cracks of the thermal barrier coating to form a “sacrificial mitigation layer” of NiO that substantially inhibits the reaction between vanadium pentoxide and yttria-stabilized compounds present in the thermal barrier coating.

The present invention relates to a new process for forming an in situ layer of protective material over a thermal barrier coating (“TBC”) used to protect the working components of a gas turbine engine and, in particular, to a new method for applying a sacrificial layer of material onto the TBC which effectively prevents the reaction of vanadium pentoxide with yttria-stabilized compounds in the TBC.

### BACKGROUND OF THE INVENTION

Most gas turbine engines operate using compressed air that is burned with hydrocarbon fuel to produce hot exhaust gases which expand across a turbine to produce power. Turbine components, particularly turbine blades, often comprise nickel-based superalloys which provide excellent resistance to creep, metal fatigue and corrosion, i.e., the principle degradation mechanisms in the hot sections of the gas turbine engine, particularly the combustion chamber and turbine. Significant advances in high-temperature applications have been made in recent years, including by General Electric, using different nickel- and cobalt-based superalloys to form the key components of gas turbine engines, particularly the combustor and augmentor sections of the engines.

Even the latest generation superalloys, however, are susceptible to damage by oxidation and hot corrosion which tend to accelerate the corrosion of the underlying metal substrate. For that reason, many engine components include some form of a thermal barrier coating. Because the number and severity of TBC applications have increased in the past decade, the premature spallation failure of TBCs during service is still a problem because a failure can often expose the bare metal to dangerously hot gases and remains a serious operational concern.

The mechanisms by which TBCs fail are also varied and complex, the most important being thermal-expansion stresses, metal oxidation and physical changes in the TBC composition and properties. Ceramic materials, particularly yttria-stabilized zirconia (YSZ), are now widely used as a thermal barrier coating in TBC systems for gas turbine engines. Typically, the TBC used in the highest-temperature regions of the engines is deposited by electron beam physical vapor deposition (EBPVD) techniques that produce a grain structure capable of expanding and contracting without causing damaging stresses that lead to spallation.

In addition, in order to promote adhesion and extend the service life of a TBC system, an oxidation-resistant bond coat is often employed, usually in the form of MCrAlX (where M is iron, cobalt and/or nickel, and X is yttrium or another rare earth element) or a diffusion aluminide coating. During exposure to high temperatures, such as during engine service, the bond coat oxidizes to form a tightly adherent alumina layer (e.g., aluminum oxide or Al₂O₃) that protects the underlying structure from catastrophic oxidation and adheres the TBC to the bond coat. Normally, the service life of a TBC system is limited by spallation at or near the interfaces of the bond coat with the TBC.

It is known that vanadium pentoxide destabilizes yttria-stabilized zirconia by reacting with the yttria. The reaction results in formation of yttrium vanadate and monoclinic zirconia according to the following reaction:

Y₂O₃₍ₛ₎(in YSZ)+V₂O₅₍ₗ₎→2YVO₄₍ₛ₎+m−ZrO₂₍ₛ₎

The monoclinic phase of zirconia as shown above (m-ZrO₂) is undesirable because it undergoes volume changes when thermally cycled, such as during the normal operation of the gas turbine engine. Such repeated cycling can lead to coating spallation and ultimately a potential catastrophic failure of critical engine components. It has been found that the problem of spallation may be accelerated by contaminants in the fuel being used to drive the gas turbine engine. That is, the hot corrosion is promoted by contaminants present in the hydrocarbon fuel and air mixture, particularly Middle East fuels containing even small amounts of vanadium. Vanadium is often found in residual fuel oils, as well as in some crude oils, typically in the form of a porphyrin or other organometallic complex. Inorganic compounds containing vanadium have also have been found in lower grade fuels.

During combustion of the fuel, the vanadium reacts with oxygen to form various oxides, including VO, V₂O₃, V₂O₄ (VO₂) and V₂O₅. VO, V₂O₃ and V₂O₄(VO₂) are considered refractory materials that have melting points above 1500° C., and thus normally will pass through the gas turbine as part of the exhaust stream. Vanadium pentoxide, V₂O, however, has a much lower melting point (in the range of about 650° C.-670° C.). Thus, V₂O₅ is normally a liquid at typical gas turbine operating temperatures and tends to deposit on the surfaces of hot components ultimately causing hot corrosion and contributing to spallation.

In the past, various additives have been used as part of the combustor fuel in an effort to inhibit vanadium hot corrosion. For example, magnesium-containing compounds (e.g., MgSO₄) have been used because they decompose to magnesium oxide (MgO), which in turn reacts with V₂O₅ to form magnesium vanadate (Mg₃(VO₄)₂). Unfortunately, various residual sulfur compounds, such as from sodium sulfates and SO₂ from the combustor fuel, tend to reduce the effectiveness of the MgO which preferentially reacts with the sulfur to form MgSO₄, rather than with V₂O₅ to form magnesium vanadate. It has been found that magnesium-based compounds added to low-grade fuels, while helping to reduce the corrosive effect of vanadium, can result in the accumulation of ash-like deposits on interior gas turbine parts, which requires periodic shutdown and maintenance of the gas turbine engine to remove the accumulated deposits.

Thus, notwithstanding various efforts in the past to control the adverse effects of vanadium pentoxide, the combustion of hydrocarbon fuels in gas turbine engines, particularly heavier fuels such as crude oils found in the Middle East which often contain vanadium, remains a serious problem, namely the accumulation of vanadium ash on the metallic surfaces of the hot gas path. Typically, the accumulated ash includes both V₂O₅ (vanadium pentoxide) and Na₂SO₄ (sodium sulfate). The ash material, which then forms a variety of sodium salts, causes fouling and corrosion of the hot gas path components due to the formation of low melting point reactive compounds containing vanadium. Eventually, as noted above, the fouling and corrosion over long periods of operation cause the metallic components to deteriorate or even fail, resulting in a need to shut down the entire gas turbine engine.

### BRIEF DESCRIPTION OF THE INVENTION

The figures and accompanying text below describe a new method for providing a protective coating on gas turbine engine components comprising the steps of forming a saturated solution of nickel acetate tetrahydrate, applying a uniform thickness of the coating onto the thermal barrier coating of selected components of the gas turbine engine, and heat treating the coated component in air at a temperature sufficient to form an integral protective layer of NiO over the thermal barrier coating. Nominally, the saturated solution of nickel-acetate tetrahydrate is applied as a liquid in an amount sufficient to form a uniform NiO layer over the thermal barrier coating with sufficient solubility at room temperature to penetrate into the microscopic cracks of the thermal barrier coating.

The NiO layer thus forms a “sacrificial mitigation layer” that substantially inhibits the reaction between vanadium pentoxide and yttria-stabilized compounds present in the thermal barrier coating by reacting with vanadium present in the exhaust stream of the gas turbine engine to form solid nickel-vanadate. Thus, in exemplary embodiments described herein, the nickel acetate tetrahydrate solution is applied in an amount sufficient to completely fill and seal all microscopic surface cracks in the thermal barrier coating, followed by a heat treatment carried out in an air furnace at a temperature of between 950° F. and 1050° F.

The present invention also includes gas turbine engine components treated in the manner described herein, i.e., components having a protective coating applied thereon which comprise a superalloy substrate, a thermal barrier coating applied to the superalloy substrate and a sacrificial NiO coating applied to the top of the thermal barrier coating. The invention also contemplates a new method for evaluating the effectiveness and expected life of a protective coating applied to the thermal barrier coating of gas turbine engine components which includes the steps of applying a uniform layer of nickel acetate tetrahydrate solution to test coupons having the same superalloy substrate and thermal barrier coating structure as selected components of the gas turbine engine, heat treating the coated test coupons in air at a temperature sufficient to form a protective layer of NiO having a defined thickness, inserting the test coupons into the gas turbine engine at locations corresponding to the target components, and determining the amount of NiO coating remaining on the test coupons after a defined period of time of operation of the gas turbine engine.

### BRIEF DESCRIPTION OF THE DRAWINGS

FIG. 1 is a schematic flow diagram showing an exemplary prior art process for treating the hot gas path of a conventional gas turbine engine in order to extract vanadium compounds present in the fuel for purposes of protecting selected TBC components from vanadium corrosion;

FIG. 2 is a schematic flow diagram depicting an exemplary embodiment of the steps taken according to the invention for forming and evaluating over time a sacrificial mitigation layer deposited on the thermal barrier coating of selected gas turbine engine components; and

FIG. 3 is a scanning electron microscope (SEM) photograph, depicting the cross section of the top surface of an exemplary gas turbine engine component having a thermal barrier coating and a NiO coating applied thereon in accordance with invention.

### DETAILED DESCRIPTION OF THE INVENTION

The present invention provides a different approach to resolving the problems inherent in using hydrocarbon fuel components in gas turbine engines that contain vanadium compounds (and thereby tend to generate vanadium pentoxide). In particular, the invention does not rely on any pre-treatment of the hydrocarbon fuel or the addition of NiO into the hydrocarbon fuel or the hot gas stream. Instead, a sacrificial mitigation layer of material is deposited directly on the thermal barrier coating of selected gas turbine engine components, namely those that form the hot gas path. The sacrificial mitigation layer effectively prevents or at least substantially inhibits the reaction over time between any vanadium pentoxide and yttria-stabilized compounds present in the TBC. Significantly, the protective layer can be formed from a saturated solution of Ni-acetate and then deposited (in effect “painted”) directly onto the TBC surface. The entire coated components then undergo a prescribed thermal heat treatment to from a sacrificial NiO layer on the TBC. The coating and heat treatment steps may also be repeated as discussed below, depending on the specific end use application.

The direct application coating method according to one aspect of the invention has been found superior in many respects to systems that introduce nickel or magnesium into the hot gas stream (or the base hydrocarbon fuel) in that the sacrificial mitigation layer tends to prolong gas turbine service life by inhibiting vanadium pentoxide from reacting with the yttria stabilized zirconia. The nickel oxide sacrificial layer on top of the TBC thus prevents adverse reactions from accruing to any significant extent until virtually all of the NiO layer has been depleted.

The use of a layer of sacrificial mitigation layer also increases the anticipated life of hot gas path components that might otherwise suffer from spallation or a destabilized TBC. As a result, from a commercial standpoint, the gas turbine engine does not need to be inspected as often, nor does the engine need to be taken out of service in order to correct an ash accumulation problem. Such increases in the projected operating time offer significant commercial advantages where the units do not need to undergo maintenance during peak critical use periods.

Nickel oxide on its own as a coating components is a relatively poor structural material. Nevertheless, nickel oxide has been found to be a valuable top coating for the TBC because it reacts with vanadium to form solid nickel-vanadate and will remain a solid at the anticipated elevated operating temperatures of most gas turbine engines. Vanadium, on the other hand, reacts with various materials to form a liquid at nominal gas turbine operating temperatures. It also reacts with MgO and NiO to produce solids. However, it has been found that nickel oxide outperforms magnesium as a potential TBC coating due to the likely interaction of the magnesium with sulfate, a compound often found in the gas turbine exhaust.

Thus, even though NiO is considered a relatively poor structural material from the standpoint of strength, it has been found to be an ideal candidate as a protective layer on top of the TBC coating. The NiO coating applied to the TBC and treated in accordance with the invention penetrates into and seals the small surface porosity and cracks in the coating. In that manner, the final nickel oxide layer prevents vanadium pentoxide from penetrating into the TBC and reacting with the yttria. Because the vanadium pentoxide tends to penetrate the TBC layer across the entire cross-section of the coating, the invention effectively prevents the undesirable reactions from progressing across the same entire cross sectional area.

An exemplary process for applying the nickel acetate tetrahydrate solution and related method of infiltration may be summarized as follows. A saturated solution of nickel acetate tetrahydrate is applied to the TBC in an amount sufficient to form a relatively uniform NiO particulate layer. The NiO-coated component then undergoes heat treatment of the NiO-coated component in air. Preferably, the saturated solution will be applied in the form of a matrix that remains a liquid and thus maintains its solubility long enough to thoroughly penetrate into the microscopic cracks of the TBC. The saturated solution is “painted” onto the thermal barrier coating to thereby infiltrate and completely fill and seal all TBC surface cracks. Normally, the entire exposed part will be coated after a thermal barrier coating heat treatment has been completed, i.e., after the TBC part has cooled to room temperature.

It has been found that the Ni-acetate tetrahydrate coated TBC component should be heat treated in an air furnace to a temperature of between 950° F.-1050° F. in order to expand the cracks and dry and convert the Ni precipitate to NiO. The engine component is held at the same temperature for a minimum of an hour and then furnace-cooled to below 800° F. before removing the component from the furnace. The same nickel acetate tetrahydrate infiltration process can be repeated a second time by painting the part with a fresh saturated solution to again infiltrate and fill all remaining surface cracks. A similar heat treatment is then undertaken as described above. The infiltration process and heat treatment can be repeated a third time, if necessary, to ensure a uniform coating with uniform structural integrity.

The following example illustrates the basic process steps and conditions used to form an in situ layer of protective material according to the invention.

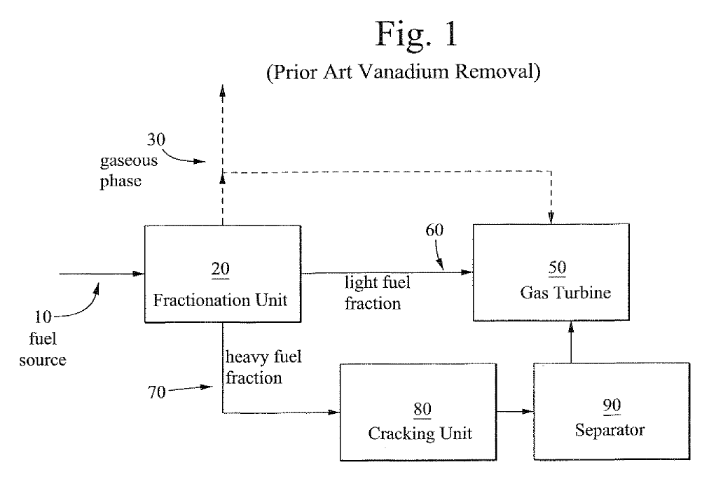

FIG. 1 is a schematic diagram depicting an exemplary prior art process for removing vanadium from fuel containing vanadium (in contrast to the present invention which, as noted above, represents a significant departure from such processes). In FIG. 1, fuel source is fed to a fractionation unit 20 comprising an adsorption material for extracting vanadium. The fuel is fractionated in fractionation unit 20 by separating the feed into a light fuel fraction 60 and a heavy fuel fraction 70. The light fuel fraction and gaseous phase are removed from the top of fractionation unit 20 and fed to a condenser (not shown). The light fuel fraction is condensed to a liquid and the gaseous phase, if present, remains in a vapor state. The condensate is then separated from the gaseous phase in separator 90. Gaseous phase 30, if any, may be combusted in a flare or fed to gas turbine 50 equipped with gas nozzles suitable for combusting hydrocarbon gases.

Notably, the condensed light fuel fraction 60 forms as a liquid having a significantly reduced amount of vanadium and may be used to fuel a gas turbine 50. The heavy fuel fraction 70 typically has a high vanadium content and can be removed from the bottom of the fractionation unit 20 to be discarded or treated further for vanadium removal in a fuel partial oxidation or autothermal cracking unit 80. Normally, the vanadium is oxidized in the fuel by partial oxidation or autothermal cracking to form a solid. As FIG. 1 illustrates, the solid vanadium and ash from the fuel partial oxidation unit or autothermal cracking unit 80 are then separated from the treated fuel in separator 90.

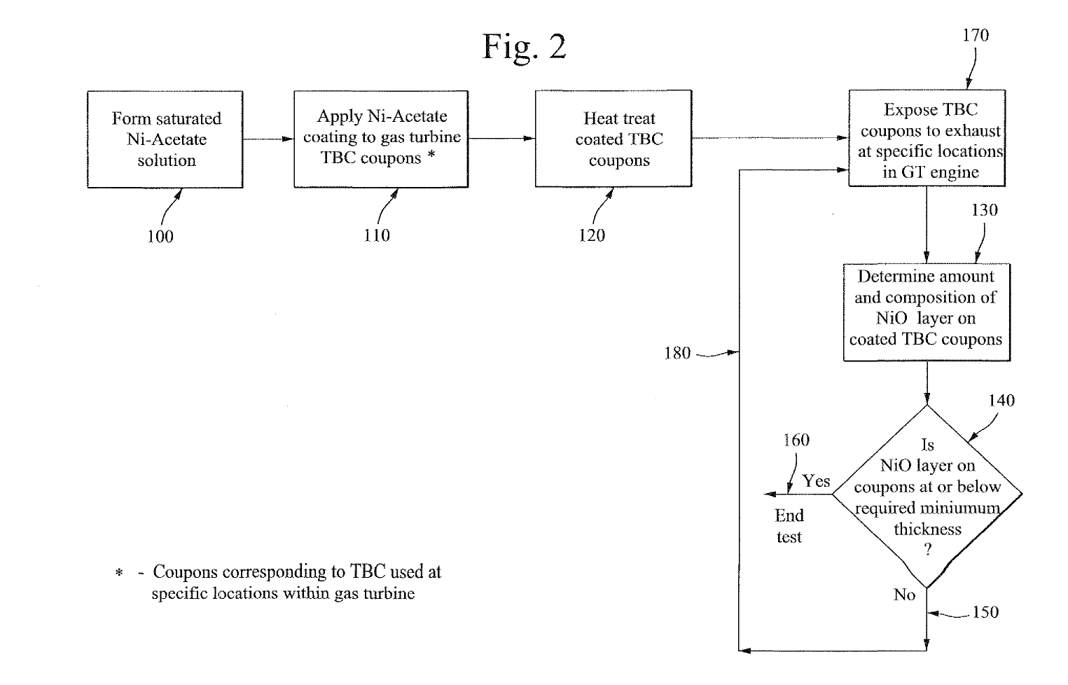

FIG. 2 is a schematic flow diagram depicting an exemplary embodiment of the steps taken according to the invention for forming and evaluating over time a sacrificial mitigation layer deposited on the thermal barrier coating of gas turbine engine components. The Ni-acetate solution is created as described above in solution forming step 100 and then applied in prescribed amounts to specific test coupons in Ni-acetate coating step 110. The amount of coating and application conditions may vary slightly for different coupons depending on the location and structure of the corresponding TBC components in the gas turbine engine.

In step 120, the test coupons are heat treated to form NiO after being allowed to penetrate into the BC as described above. Again, the precise heat treatment and coating parameters for different coupons may vary slightly, depending on the exact location within the gas turbine engine in which they reside, Nominally, the coupons are coated and heat treated multiple times in order to ensure the structural integrity and uniform thickness of the final coating before being subjected to industrial gas turbine operating conditions.

Once treated, the coated coupons are exposed to the gas turbine exhaust at specific locations at step 170 with the installation taking place in a manner that allows the coupons to be physically removed and analyzed after fixed periods of time without shutting down the gas turbine engine. After a prescribed period of operation, the coupons can be removed as shown in step 130 in order to determine the exact amount and composition of the remaining NiO layer. If, as indicated at step 140, the NiO layer has retained sufficient thickness and the NiO matrix has not deteriorated during the period of evaluation (see decision line 150), the coupon is returned to the same location inside the engine and the test continued as indicated at coating test feedback line 180. If, on the other hand, the coupon reflects a thickness decrease that endangers the underlying TBC, the test is discontinued at “Yes” line 160, indicating a possible shutdown of the engine for periodic maintenance. As noted above, the time period between such maintenance shutdowns should be extended using the NiO coatings according to the invention.

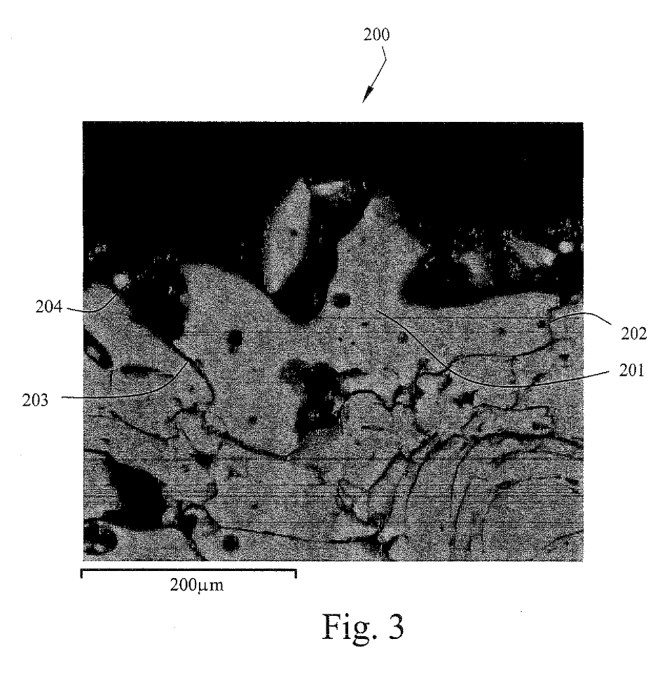

FIG. 3 of the drawings is a scanning electron microscope (“SEM”) photograph depicting the top surface of an exemplary gas turbine engine component having a single thermal barrier coating and a protective NiO coating applied thereon in accordance with the invention. A small cross section of the coated engine component is shown generally at 200 having thermal barrier coating 201 (such as an yttria-stabilized zirconia) applied to the top surface thereof.

FIG. 3 also shows the presence of microscopic cracks 202 and 203 in the TBC, some of which extend up to the top surface of the coating, thereby making the TBC vulnerable to a reaction between vanadium pentoxide and the yttria-stabilized compounds in the TBC, i.e., by reacting with vanadium present in the gas turbine exhaust stream that forms nickel-vanadate. The NiO layer 204 in FIG. 3 forms a “sacrificial mitigation layer” that protects the underlying TBC from the unwanted vanadate reaction. As noted above, NiO layer 204 is formed by initially applying a saturated liquid solution of nickel-acetate tetrahydrate in an amount sufficient to form a substantially uniform NiO layer over the TBC at room temperature and capable of penetrating into microscopic cracks 202 and 203. The relative thicknesses of the TBC and NiO layers can be seen by comparison to the 200 μm scale shown at the bottom left of FIG. 3. Additional NiO layers can be deposited as described above, depending on the specific engine component involved and desired final NiO thickness.

While at least one embodiment of the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for applying a protective coating to a gas turbine engine component, comprising:
forming a saturated solution of nickel acetate tetrahydrate;
applying a uniform layer of said nickel acetate tetrahydrate solution to selected components of said gas turbine engine; and
heat treating said coated component in air at a temperature sufficient to form a protective layer of NiO over said thermal barrier coating.

2. A method according to claim 1, wherein said saturated solution of nickel-acetate tetrahydrate is applied as a liquid in an amount sufficient to form a uniform NiO layer over the thermal barrier coating of said gas turbine engine component following heat treatment.

3. A method according to claim 1, wherein said saturated solution of nickel-acetate tetrahydrate maintains sufficient solubility at room temperature to penetrate into the microscopic cracks of said thermal barrier coating.

4. A method according to claim 1, wherein said step of applying said uniform layer of said nickel acetate tetrahydrate solution is carried out after the thermal barrier coating has been heat treated and cooled to room temperature.

5. A method according to claim 1, wherein said NiO layer forms a sacrificial mitigation layer that substantially inhibits the reaction between vanadium pentoxide and yttria-stabilized compounds present in said thermal barrier coating.

6. A method according to claim 1, wherein said NiO reacts with vanadium present in the exhaust stream of said gas turbine engine to form solid nickel-vanadate.

7. A method according to claim 1, wherein said nickel acetate tetrahydrate solution is applied in an amount sufficient to completely fill and seal all microscopic surface cracks on the top surface of said thermal barrier coating.

8. A method according to claim 1, wherein said step of heat treating said coated gas turbine engine component is carried out in an air furnace at a temperature of between 950° F.-1050° F.

9. A method according to claim 1, wherein said step of heat treating said coated gas turbine engine component causes microscopic surface cracks in said thermal barrier coating to expand and allow for the penetration of said nickel acetate tetrahydrate solution into the expanded cracks.

10. A method according to claim 7, wherein said nickel acetate tetrahydrate solution penetrates into said microscopic surface cracks in said thermal barrier coating where the coating dries and the Ni precipitates to form NiO.

11. A method according to claim 1, wherein said gas turbine engine component is held at the same temperature for a minimum of about one hour and then furnace-cooled to below 800° F. before removing said component from the furnace.

12. A method according to claim 1, further comprising the steps of applying a second coating of a nickel acetate tetrahydrate solution to infiltrate and fill any remaining surface cracks in said gas turbine engine component and thereafter heat treating said coated component a second time.

13. A method according to claim 1, further comprising the step of applying a third coating of a nickel acetate tetrahydrate solution to infiltrate and fill any still remaining surface cracks in said gas turbine engine component and thereafter heat treating said coated component a third time.

14. A method according to claim 12, wherein said step of heat treating said coated gas turbine engine component a second time is carried out in an air furnace at a temperature of between 950° F.-1050° F.

15. A method according to claim 13, wherein said step of heat treating said coated gas turbine engine component a third time is carried out in an air furnace at a temperature of between 950° F.-1050° F.

16. A method according to claim 1, wherein said nickel acetate tetrahydrate solution is spray painted at room temperature onto the thermal barrier coating and then heat treated.

17. A gas turbine engine component having a protective coating applied thereon, comprising
a superalloy substrate;
a thermal barrier coating applied to said superalloy substrate; and
a sacrificial NiO coating applied to the top of said thermal barrier coating.

18. A gas turbine engine component according to claim 17, wherein said thermal barrier coating comprises an oxidation-resistant bond coating of MCrAly.

19. A method for evaluating the effectiveness and expected life of a protective coating applied to the thermal barrier coating of a gas turbine engine component, comprising
applying a uniform layer of nickel acetate tetrahydrate solution to test coupons comprising the same superalloy substrate and thermal barrier coating structure as selected components of said gas turbine engine;
heat treating said coated test coupons in air at a temperature sufficient to form a protective layer of NiO having a defined thickness over said thermal barrier coating;
inserting said test coupons into said gas turbine engine at locations corresponding to said selected components;
determining the amount of NiO coating remaining on said test coupons after a defined period of time of operation of said gas turbine engine;
comparing said NiO coating thickness to specific NiO target values assigned to said selected components; and
removing said test coupons and shutting down said gas turbine engine when one or more of said NiO thickness levels fall below said NiO target values.

20. A method of evaluation according to claim 19, wherein said steps of applying a uniform layer of nickel acetate tetrahydrate and heat treating said coated test coupons is repeated.
